(19) United States
(12) Patent Application Publication
(10) Pub. No.: US 2026/0091500 A1
(43) Pub. Date: Apr. 2, 2026

(54) METHOD AND APPARATUS FOR ROBOTIC ASSEMBLY OF MOTHERBOARD WITH COMPONENTS

(71) Applicant: Bright Machines, Inc., San Francisco, CA (US)

(72) Inventors: Nikolay Shtanikov, San Bruno, CA (US); Emmanuel Gallo, Oakland, CA (US); Nicholas Iacovacci, San Francisco, CA (US); Peter Elijah Paulson, San Francisco, CA (US); Yevgeniy Guy Tubin, San Francisco, CA (US); Murali Pappoppula, Fremont, CA (US)

(73) Assignee: Bright Machines, Inc., San Francisco, CA (US)

(21) Appl. No.: 19/342,421

(22) Filed: Sep. 26, 2025

Related U.S. Application Data
(60) Provisional application No. 63/700,498, filed on Sep. 27, 2024.

(51) Int. Cl. B25J 9/16; B25J 19/02

(52) U.S. Cl. CPC B25J 9/1687; B25J 9/1697; B25J 19/023

(57) ABSTRACT

A method of inserting components into a motherboard comprising setting up a robotic cell including an end-of-arm tool, attaching a first tray feeder including a plurality of trays for the motherboards, and attaching a second tray feeder including a plurality of trays with the components. The method comprises loading a motherboard from the first tray feeder, identifying the motherboard, and identifying a component type based on the identifying of the motherboard. The method further comprises retrieving a tray with one or more components of the identified component type from the second tray feeder inserting the components into the motherboard.

### RELATED APPLICATIONS

The present application claims priority to U.S. Provisional Application 63/700,498 filed on Sep. 27, 2024, and incorporates that application in its entirety.

### FIELD

The present invention relates to robotic assembly, and more particularly to inserting components into a motherboard using a robotic system.

### BACKGROUND

While automation equipment and methods have been available for manufacturing products for decades, such automation systems are not always employed, and instead human labor is still commonly used to perform tasks such as inserting components into a motherboard.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is an illustration of one embodiment of a robotic cell with two tray feeders, for assembling motherboard-DIMM combinations.

FIG. 2A is an illustration of one embodiment of the interior of the robotic cell for assembly.

FIG. 2B is a top view of one embodiment of the interior of a robotic cell.

FIG. 3A illustrates one embodiment of the motherboard fixtured on a tray.

FIG. 3B illustrates one embodiment of the DIMM modules fixtured on a tray.

FIGS. 4A-4C illustrate embodiments of a custom support base for supporting a motherboard.

FIG. 4D illustrates one embodiment of a spring plunger to position the motherboard on the custom tray.

FIG. 5A illustrates one embodiment of the fields of view of a four-camera setup for navigation and inspection.

FIG. 5B illustrates one embodiment of the camera components coupled to the robotic cell frame.

FIG. 5C illustrates a perspective view of the camera assembly of FIG. 5B.

FIG. 6 illustrates one embodiment of an end-of-arm DIMM inserter component with a scanner.

FIG. 7A is an illustration of one embodiment of an open reject drawer installed in a robotic cell.

FIG. 7B is an illustration of one embodiment of the reject drawer interior that is coupled into the robotic cell.

FIG. 7C is an illustration of one embodiment of the reject drawer alerting for replacing the drawer.

FIG. 8A is a flowchart of one embodiment of setting up for assembly.

FIG. 8B is a flowchart of one embodiment of supporting the robotic cell during assembly.

FIG. 9A-9B is a flowchart of one embodiment of assembling using the system.

FIG. 10A is a flowchart of one embodiment of populating a Genealogy Cloud for tracking.

FIG. 10B is a flowchart of one embodiment of using a Genealogy Cloud for tracking.

FIG. 11 is a flowchart of one embodiment of inspection of the motherboard.

FIG. 12 is a flowchart of one embodiment of latch inspection using end of arm cameras.

FIG. 13 is a block diagram of one embodiment of a computer system that may be used with the present invention.

### DETAILED DESCRIPTION

The present system provides an automation solution to insert components, such as dual in-line memory modules (DIMMs) directly on motherboards before the motherboard is screwed into a chassis. In one embodiment, this process can be performed offline and away from the main assembly line and the assembly line will receive motherboards with the components already installed.

In the prior art, such assembly was a manual process, which is time consuming and more expensive than the automated process described here. However, because motherboards are sensitive, the present system is designed to insert components with sufficient accuracy and support to ensure that the motherboard is not damaged, and all components are correctly inserted. This automated, separate insertion will increase first-pass yield (FPY) or throughput yield, for assembly of completed systems including the motherboard. In addition, the process increases flexibility for assembly, simplifies new product introduction (NPI), and simplifies operations not well adapted for automation, and simplifies the process for servers at different heights. It also reduces the factory floor footprint of the complete assembly system, as the stand-alone robotic cell can be flexibly positioned. Thus, the system provides an improvement to an existing technology of computer system assembly.

The present system in one embodiment utilizes an independent robotic cell with one or more associated tray feeders to assemble components, such as dual in-line memory modules (DIMMs) into a motherboard. Although the below examples focus on the insertion of DIMMs, one of skill in the art would understand that this process may be used to insert other components, such as peripheral components inserted into PCI/PCIe (peripheral component interconnect/peripheral component interconnect express) expansion slots, heatsinks, additional chips, cable insertions, etc.

In one embodiment, the system includes two tray feeders, one for motherboards and one for components. In another embodiment, a single tray feeder may be used. In another embodiment, more than two tray feeders may be used. For example, there may be two tray feeders for motherboards, and one tray feeder of components. As an alternative there may be one or more tray feeders for components and one or more tray feeders for motherboards. In one embodiment, the system may include more than one type of component for insertion, as long as the robotic cell's end of arm tool(s) can handle the assembly of each of the component types. In one embodiment, the robotic cell may include two robot arms, with different end-of-arm tools.

The motherboards are positioned on a custom support base, which ensures that the motherboard remains in a fixed position and is not bent by the force of the insertion. Because the motherboard is freestanding, the use of a custom support base provides the fixed structure that would normally be provided by the chassis into which the motherboard is assembled.

The present system in one embodiment also provides the ability to add more motherboards and DIMMs into the tray feeder, while the robotic cell is active during the assembly process, without stopping the robotic cell. This enables the continuous assembly of motherboards, without pausing to reload the tray feeders. In one embodiment, the system also includes a reject drawer for DIMM modules that do not work or do not pass inspection.

In one embodiment, the system provides a recovery process as well, if an insertion fails. In one embodiment, the system also provides a pre-inspection of the motherboard, and a post-inspection after all components are populated. In one embodiment, the details of the pre-and post-inspection are recorded in a database entry associated with the motherboard. In one embodiment, the database entry further includes sensor data recorded during the insertion. This provides a record of the insertion process, which is used as a genealogy system that allows tracking of motherboards, components, and processes. This permits full traceability and secure tracking of the intricate history of every unit and component, ensuring both airtight security and efficient production.

The following detailed description of embodiments of the invention make reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

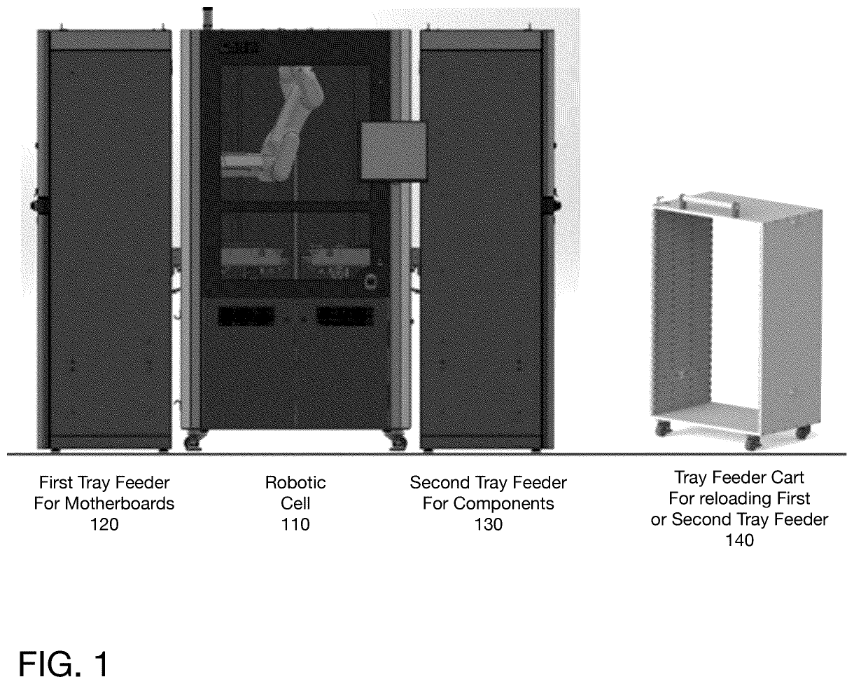

FIG. 1 is an illustration of one embodiment of a robotic cell with two tray feeders, for assembling motherboard-component combinations. The robotic cell 110 in one embodiment has two attached tray feeders, a first tray feeder 120 for the motherboards, and a second tray feeder 130 for the components to be attached to the motherboards. The first tray feeder 120 provides a motherboard, and the robot arm in robotic cell 110 takes one or more components from a tray from the second tray feeder 130 and inserts them into the motherboard. In one embodiment, the component may be a dual in-line memory module (DIMM), and a single motherboard may include between 1 and 64 DIMM modules, in one embodiment.

In one embodiment, a tray feeder cart 140 may be used to load additional motherboards and/or components into the appropriate tray feeder. In one embodiment, the time to reload the tray feeder is sub-90-seconds. In one embodiment, the reloading may occur without interrupting or slowing down the assembly process by the robotic cell 110.

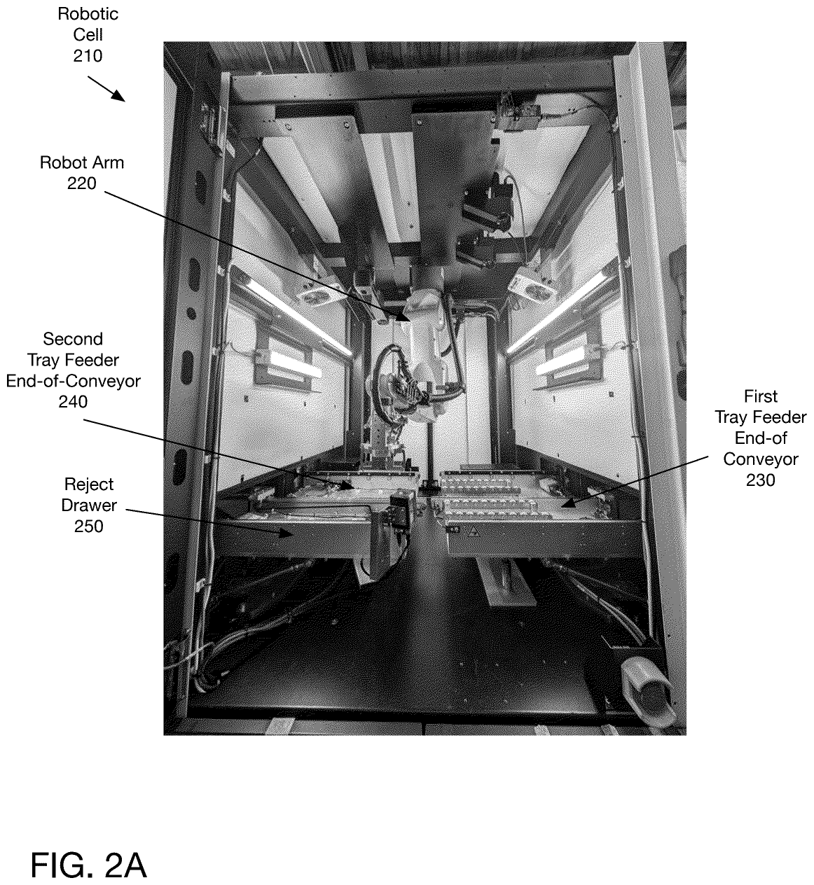

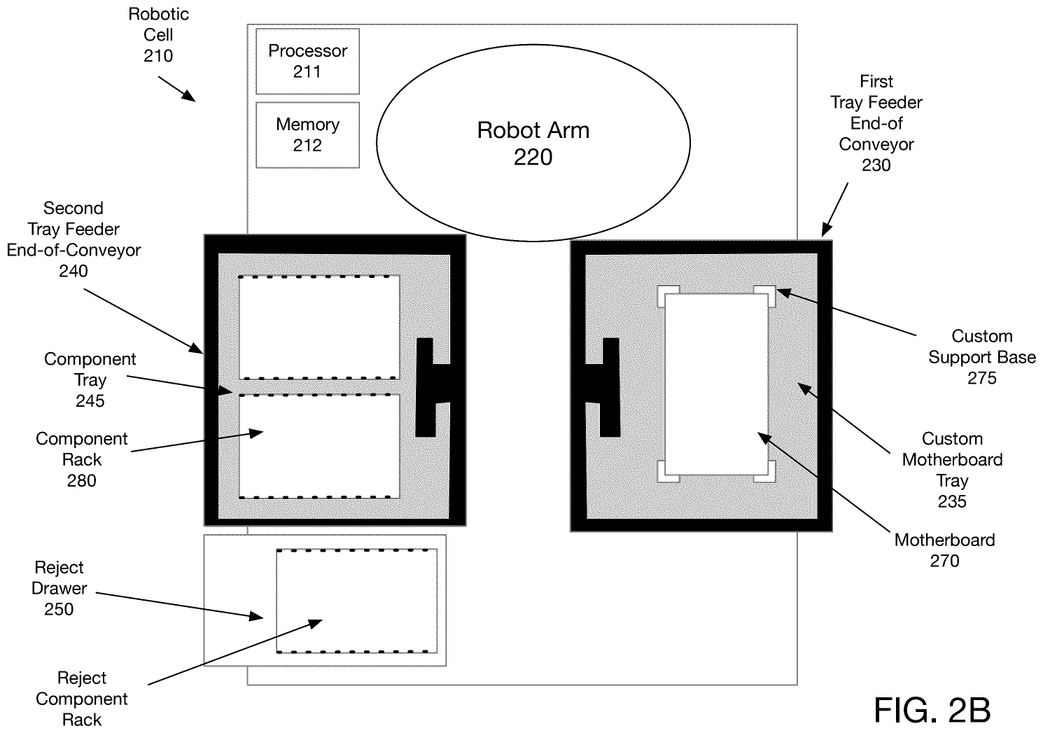

FIG. 2A is an illustration of one embodiment of the interior of the robotic cell for assembly. The interior of the robotic cell 210 includes a robot arm 220, which performs the assembly. Two tray feeders provide components for the robot arm in this configuration. In this illustration, the first tray feeder 230 provides one or more motherboards in a tray (not shown). The second tray feeder 240 provides components. The tray feeders include a conveyor to move the tray including the motherboard/component into the robotic cell interior. The robotic cell then takes the components from the second tray feeder tray and inserts them into the motherboard on the first tray feeder tray. The motherboard is not removed from the end of the tray feeder conveyor, in one embodiment. In one embodiment, if a component is found to be defective or the incorrect configuration, the robot arm 220 places that component in a reject drawer 250.

Once a motherboard is fully populated with components, as confirmed by the post-inspection, the first tray feeder 230 pulls the tray with the completed motherboard back in the tray feeder and presents a new tray with a new motherboard to the robotic cell 210. In this way, the automatic assembly process can populate motherboards with components, without requiring human input or supervision.

FIG. 2B is a simplified top view of one embodiment of the interior of a robotic cell. As can be seen, the first tray feeder 230 moves the motherboard tray 235 into the robotic cell 210. The second tray feeder 240 moves the component tray 245 into the robotic cell 210. The robot arm 220 takes a component from the component rack 280, and places it in the appropriate position on the motherboard 270 which remains on the custom support base 275 on the motherboard tray 235. If the component is not good, the robot arm 220 places the component in the reject component rack 255 in reject drawer 250. Thus, the components in component rack 280 and the motherboard on the custom support base 275 remain on the end of the conveyor through the process, in one embodiment. The robotic cell 210 includes a processor 211 and memory 212 in one embodiment, enabling the robotic cell to operate offline. In some embodiments, the robotic cell 210 also includes a network connection to upload data to a server, and receive data from a server. In some embodiments, the machine learning system described below operates on the processor 211 of the robotic cell, not requiring connection to the cloud or a server. In other embodiments, the machine learning system may utilize remote or distributed processing. In some embodiments, part of setting up the robotic cell is downloading a trained machine learning system to the robotic cell 210.

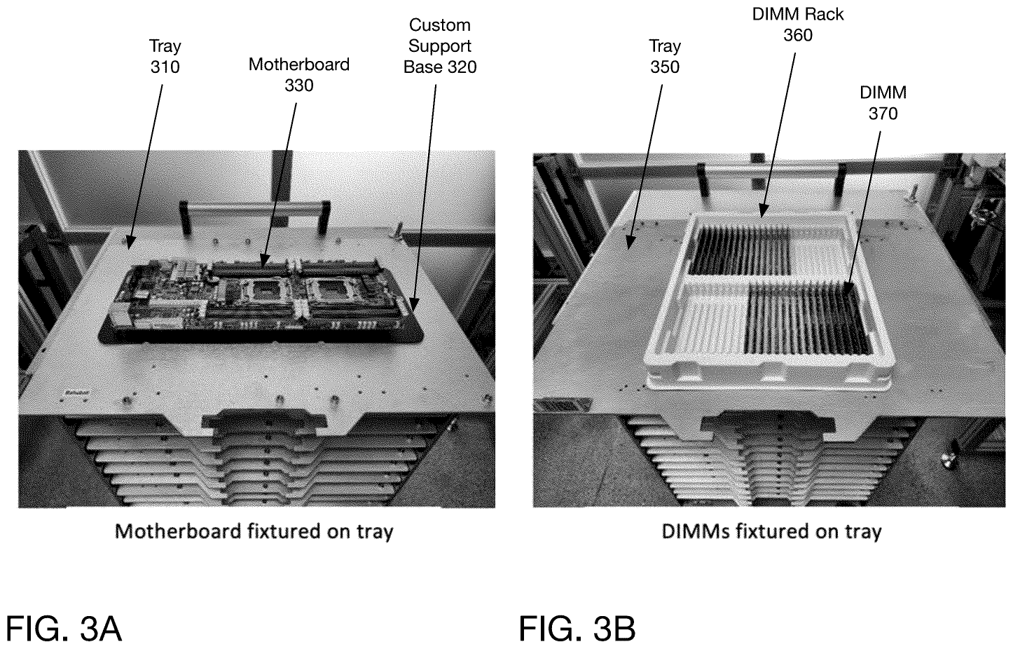

FIG. 3A illustrates one embodiment of the motherboard fixtured on a tray. The tray 310 includes a custom support base 320, on which the motherboard 330 is placed. In the illustrated configuration the tray 310 supports a single motherboard 330. However, in other embodiments, there may be multiple motherboards on a single tray. The motherboard 330 remains on the tray 310 during the assembly process, and the custom support base 320 provides structural support for the motherboard during the insertion process. In one embodiment, the custom support base 320 is affixed to the tray 310 so that it cannot move.

FIG. 3B illustrates one embodiment of the DIMMs fixtured on a tray. The tray 350 includes a DIMM rack 360, which includes a plurality of DIMMs 370. The illustrated DIMM rack 360 is only partially populated. In one embodiment, the DIMM rack 360 is fully populated initially. In one embodiment, 20-100 DIMMs may be on a single DIMM rack 360, depending on the DIMM configuration. In one embodiment, the DIMM rack 360 is affixed to the tray so that it cannot move. The DIMM rack 360 includes slots for DIMMs. Alternative modules may be on a tray in addition to or instead of the DIMMs.

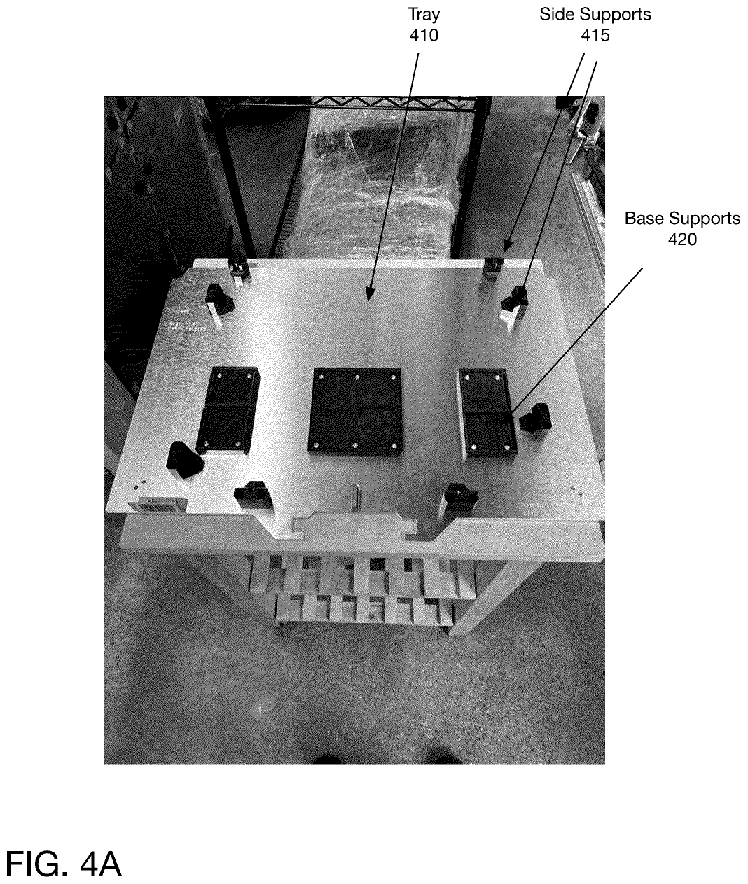

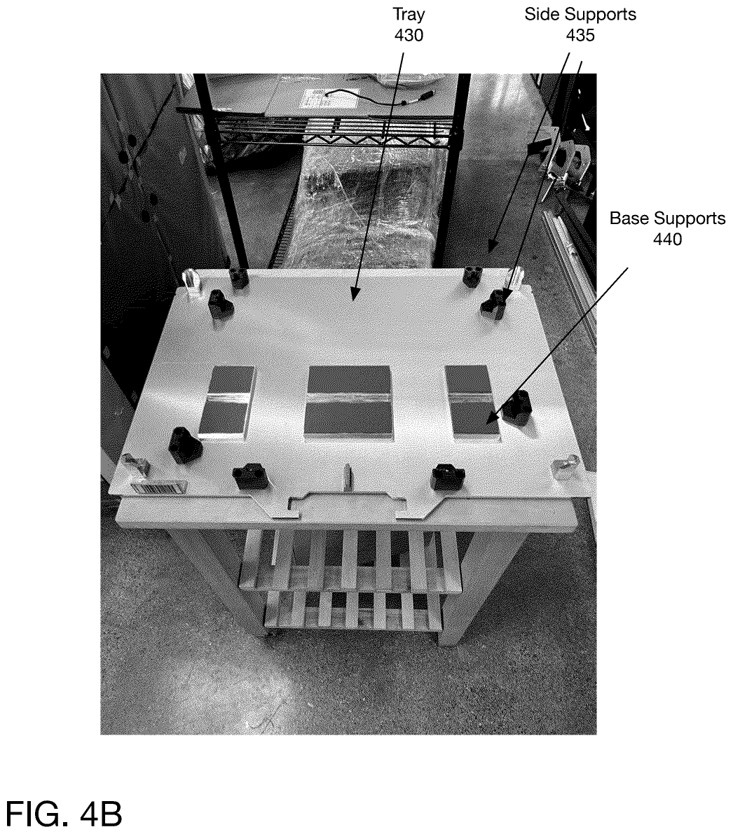

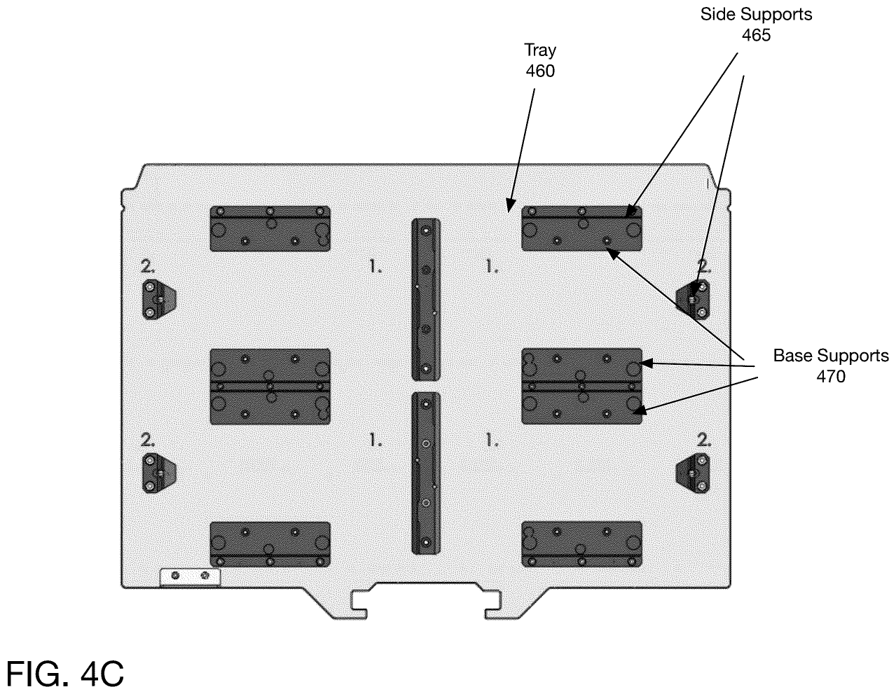

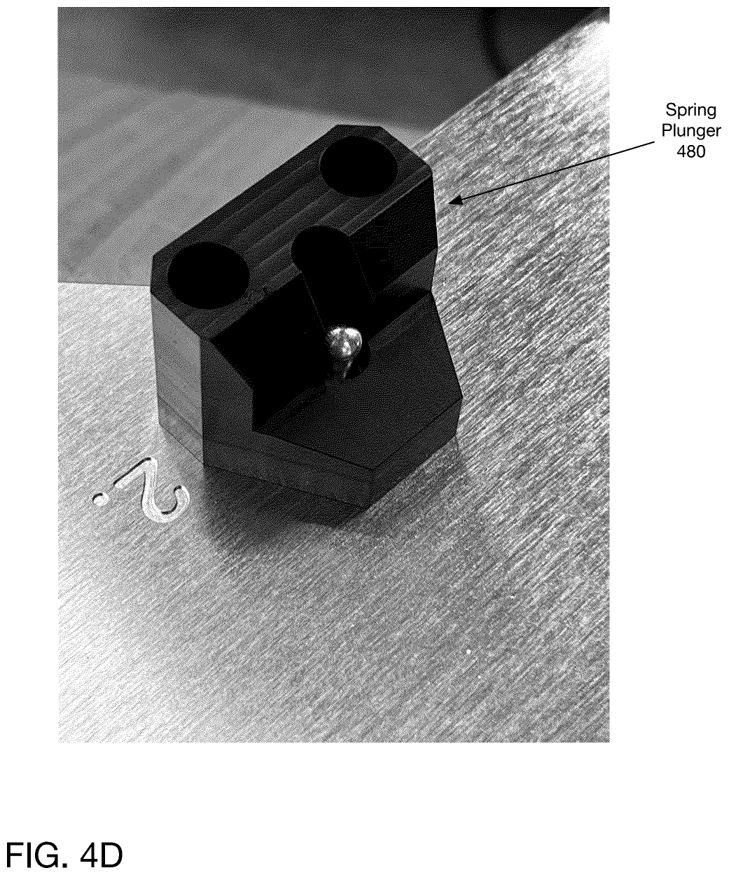

FIGS. 4A-4C illustrate embodiments of a custom support base for supporting a motherboard. FIG. 4A illustrates a tray 410 including the custom support base which includes a plurality of side supports 415, and a plurality of base supports 420. The side supports 415 ensure that the motherboard does not shift on the tray during movement or insertion. The base supports 420 ensure that the motherboard does not flex, or that flex is minimized, during insertion, which may cause errors and may damage the motherboard or the component being inserted. In one embodiment, the base supports 420 are positioned where the components are to be inserted. In one embodiment, the configuration of the base supports 420 is such that components on the bottom of the motherboard are not impacted by the supports. Thus, rather than a solid support across the bottom of the motherboard, the base supports 420 are positioned selectively where additional structural support is needed for the specific motherboard configuration, and in a way not to interfere with other components on the motherboard.

FIG. 4B illustrates another configuration in which side supports 435 and base supports 440 are differently positioned on a tray 430. FIG. 4C illustrates another configuration in which the tray 460 supports four motherboards, with side-supports 465 shared between motherboards, and each motherboard location including appropriate base supports 470. In one embodiment, the base supports 470 may be integrated with the side supports, if the components are in close proximity to the edges of the motherboard and the bottom of the motherboard does not have any potentially conflicting structures. In one embodiment, for some configurations of motherboards, the base supports may be eliminated, if there is no risk of flexing that may damage the motherboard or make the insertion of components problematic.

One of skill in the art would understand that the specific positioning of the side supports, and base supports is defined by the configuration of the motherboard and may be altered without departing from the scope of the present invention. The side supports are designed to position the motherboards for the robotic insertion and prevent movement in the horizontal direction, while the base supports are designed to provide support in the locations where components are inserted and prevent bending or flexing of the board during the insertion process.

FIG. 4D illustrates one embodiment of a spring plunger used as a side support to position the motherboard on the custom tray. In one embodiment, one or more of the side supports are spring plungers. The spring plunger 480 is a component that has a spring force to return to the center but has some amount of mobility. It is used to apply a constant force to the motherboard, to keep it in a fixed position. The strength of the spring in the spring plunger 480 is designed for the motherboard, to ensure that it applies an amount of force that stabilizes the motherboard but does not bend or deform it. In one embodiment the spring plunger has a forward face which is aligned to the motherboard. In one embodiment, the contact areas of the spring plunger 480 are made of rubber or a similar material.

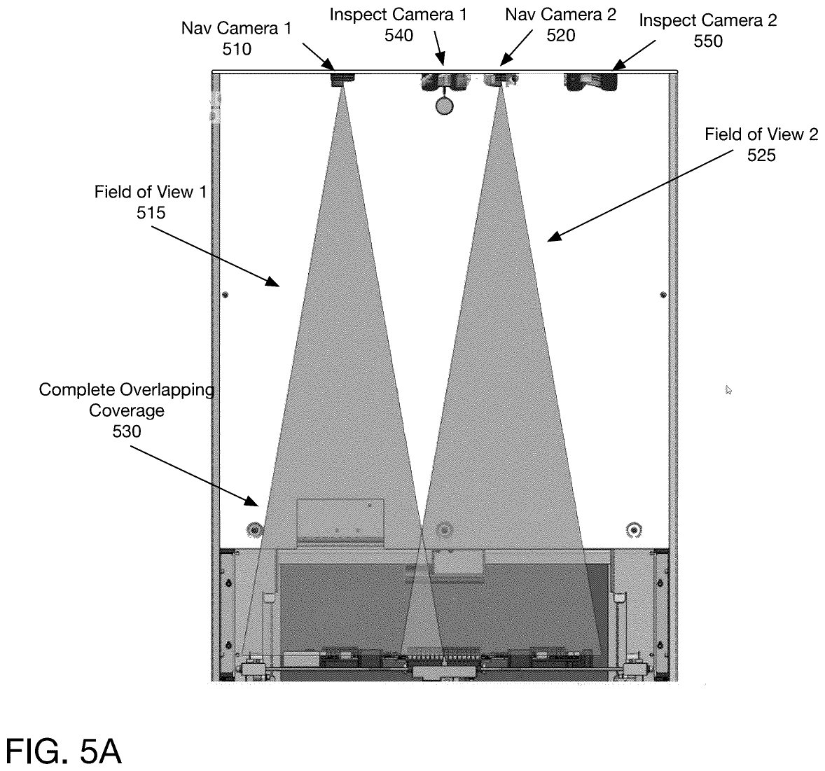

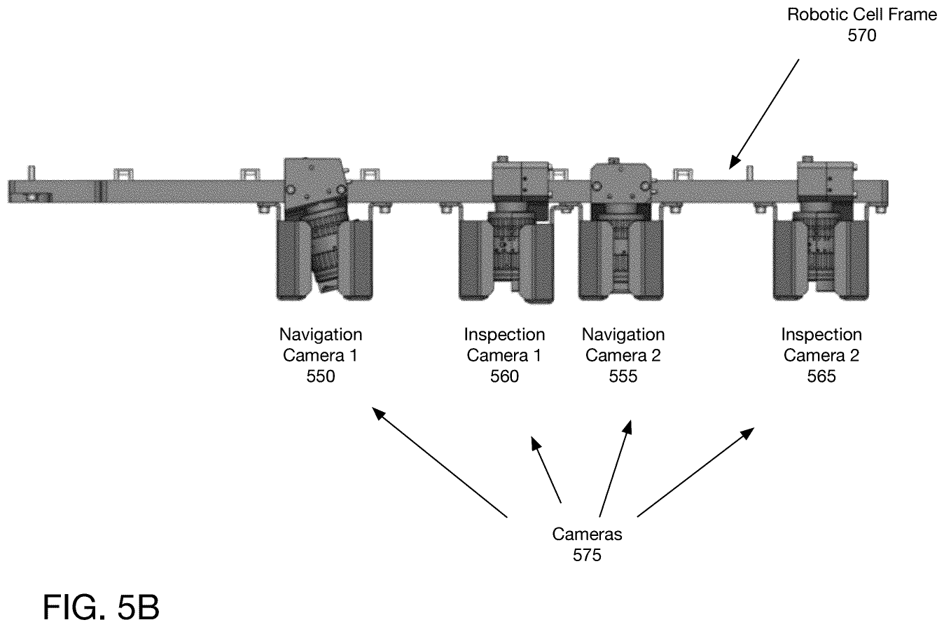

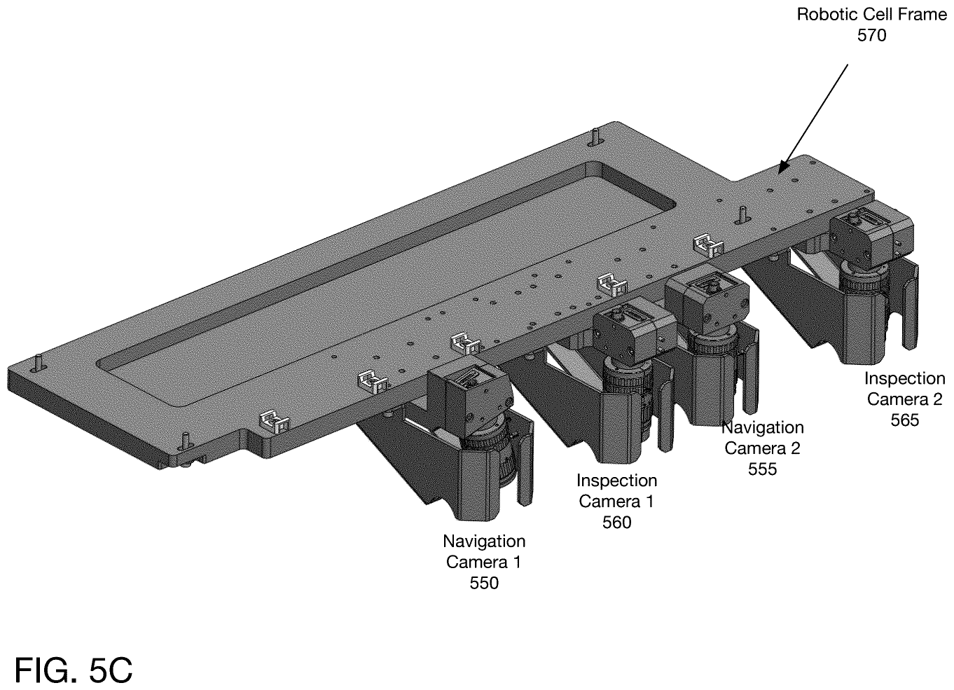

FIG. 5A illustrates one embodiment of the fields of view of a four-camera setup for navigation and inspection. Using a multi-camera stereo vision provides accurate location in three-dimensional space. In one embodiment, more cameras may be used. In one embodiment, the cameras may be replaced by or supplemented by other sensors.

The system includes in one embodiment a pair of top-mounted navigation cameras 510, 520, which provide complete overlapping coverage field of view 530 of the robotic area where assembly takes place, based on the overlapping field of view 515 of the first camera 510, and field of view 525 of the second camera 520. The inspection cameras 540, 550 also provide overlapping coverage. In one embodiment the inspection cameras 540, 550 are used to perform a pre-inspection prior to the insertion of components into the motherboard, and a post-inspection, after the components have been inserted into the motherboard. In one embodiment, by using separate cameras for navigation and inspection, the system can maximize the overlap between the images for navigation and maximize the coverage area for inspection. In some embodiments, in addition to the top mounted cameras, the system may include an end of arm (EoA) camera, as will be discussed below.

FIG. 5B illustrates one embodiment of the camera components coupled to the robotic cell frame for the top-mounted navigation cameras, and FIG. 5C illustrates a perspective view of the camera assembly of FIG. 5B. The cameras 575 include two navigation cameras 550, 555, and two inspection cameras 560, 565, in one embodiment. The cameras 575 in one embodiment are fixed to the robotic cell frame 570. The robotic cell frame 570 is rigid and solid, and provides stability for the cameras 575, and ensures that once the cameras are calibrated, they will remain in their calibrated positions. In one embodiment, the cameras 575 are adjustable, so that the initial configuration can set the cameras to provide complete coverage of the active area of the cell, referred to as the working area.

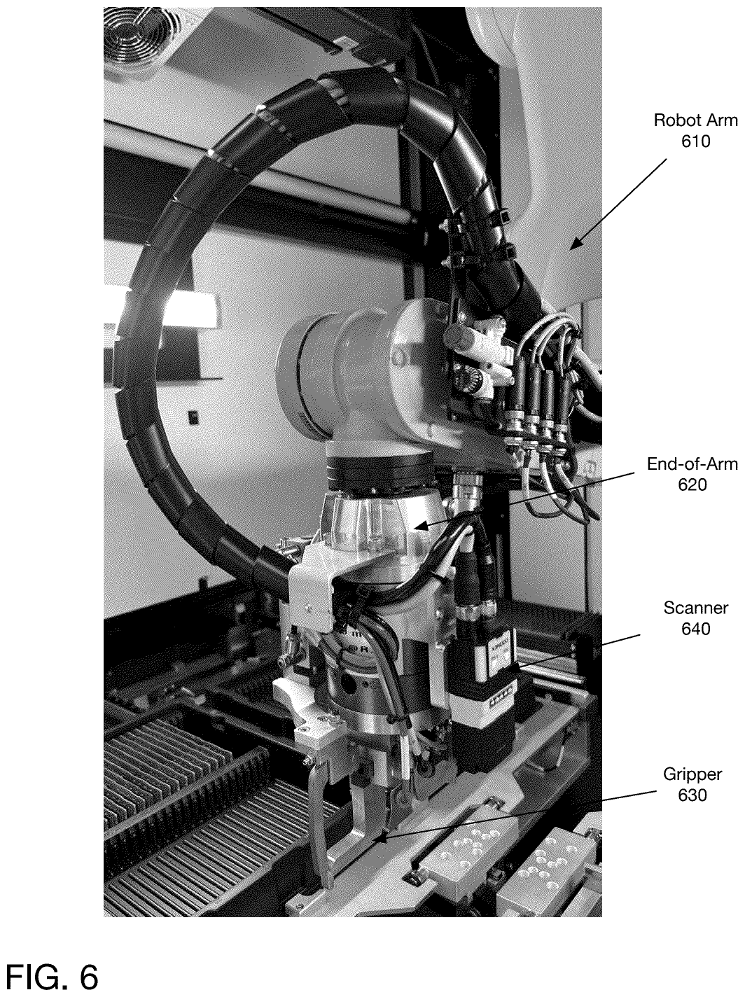

FIG. 6 illustrates one embodiment of an end-of-arm DIMM inserter component with a scanner. In one embodiment, the robot arm 610 in the robotic cell is used to place components into the motherboard. The illustrated robot arm 610 includes an end-of-arm component 620 including grippers 630 for inserting DIMM (dual inline memory modules) into a motherboard. In addition, the robot arm 610 includes a scanner 640, in one embodiment. The scanner 640 may be used to scan an identification on the motherboard to obtain a motherboard ID. The motherboard ID is then used to associate the data captured during the component insertion with the individual motherboard.

In one embodiment, a database is used that includes information from the insertion process associated with the motherboard ID. In one embodiment, the scanner 640 may also be used to scan information on components, component racks, component trays, and/or motherboard trays. In one embodiment, the scanner 640 may scan a two dimensional barcode such as a UPC (universal product code), QR (quick response) code, or other marking, which provides identifying information. In another embodiment, the scanner may be replaced by an RF (radio frequency) scanner, and the barcodes by RF tags. In another embodiment, the scanner can be replaced by a camera, or one of the existing inspection or navigation cameras may be used to obtain component information. Other ways of uniquely identifying motherboards may be used.

In some embodiments, the end of arm component 620 may include a camera, which can be used during insertion for positioning and/or during inspection for verifying that the insertion was successful.

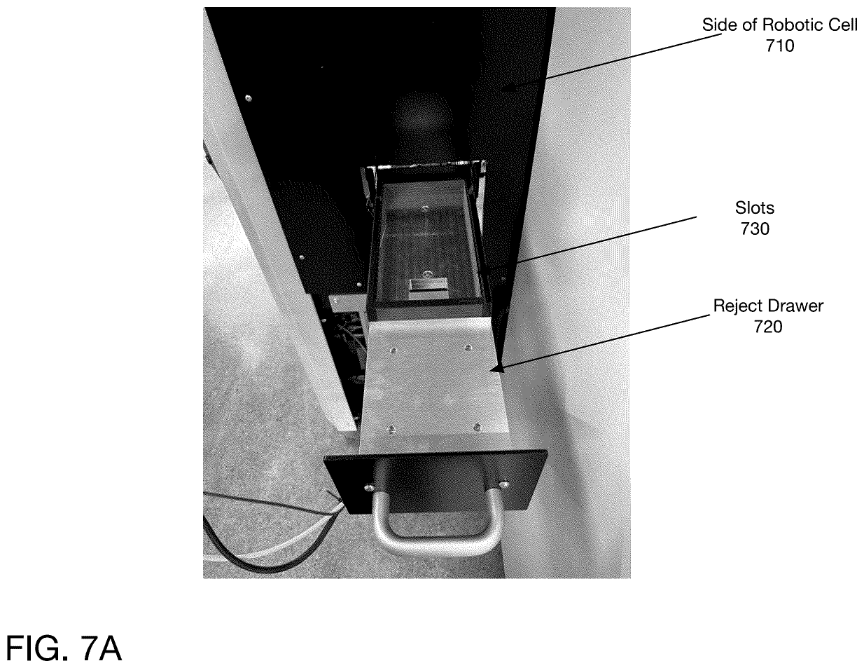

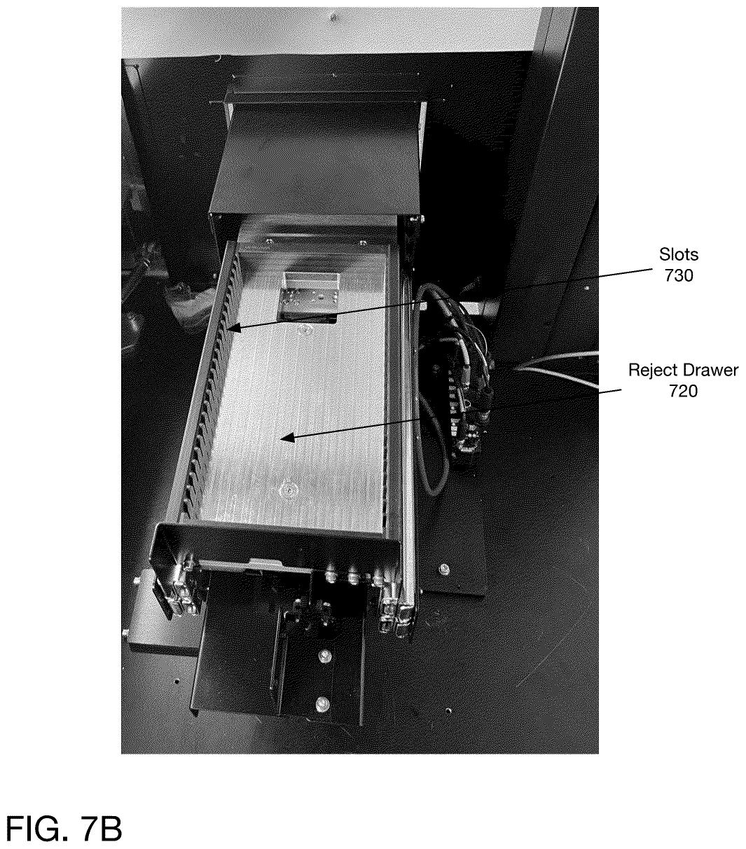

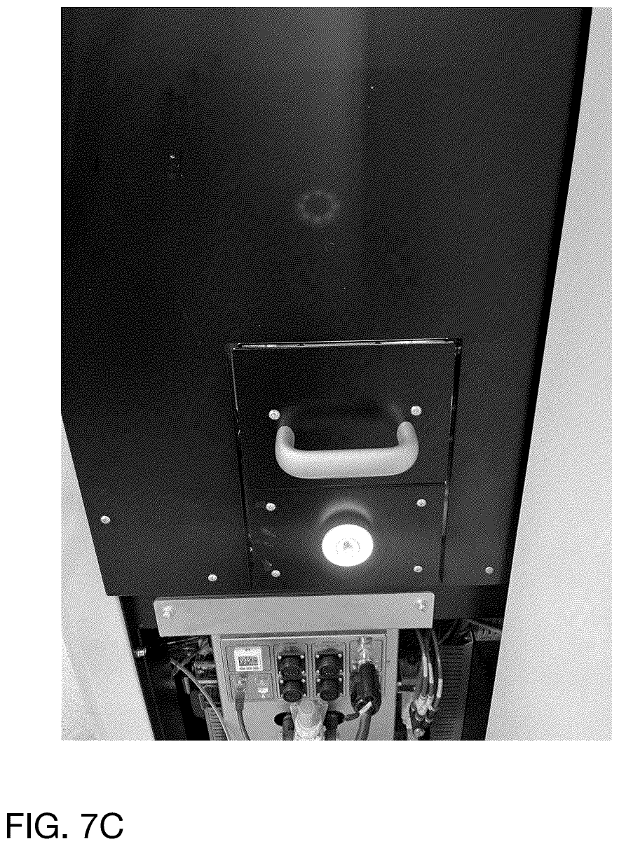

FIG. 7A is an illustration of one embodiment of an open reject drawer installed in a robotic cell. The side of the robotic cell 710 is shown, with an open reject drawer 720. The reject drawer 720 in one embodiment includes a plurality of slots 730 into which individual rejected components may be inserted. In one embodiment, the slots are spaced for the component size, e.g., for the DIMM modules being used. In another embodiment, for a differently shaped component, the reject drawer 720 would include an appropriately shaped receptacle to receive a plurality of rejected components. In some embodiments, the reject drawer 720 may be replaced by a disposal location that does not include individual slots for components.

In one embodiment, when the system determines that a component picked up by the robot arm is defective of otherwise cannot be used, either prior to insertion or after failing insertion of the component into the motherboard, the component may be placed by the robot arm into the reject drawer. The reject drawer 720 generally resides within the robotic cell, as shown in FIG. 2A. The reject drawer 720 can be pulled out, to replace a full drawer with an empty one, during the operation of the robotic cell. This enables the robotic cell to continue operating without interruption. The replacement of the full drawer with an empty one may be automatic, or may be done manually by an operator.

FIG. 7B is an illustration of one embodiment of the reject drawer interior that is coupled into the robotic cell. This image shows the window in the wall of the robotic cell through which the reject drawer is inserted. During normal assembly operation, the reject drawer 720 is positioned next to the tray with the components for insertion, in one embodiment. In one embodiment, there is a sensor in the reject drawer which senses when all of the available slots/positions in the reject drawer are occupied. The system then alerts an operator to replace the tray in the reject drawer with a fresh tray. FIG. 7C is an illustration of the light that may be used in one embodiment of the reject drawer for alerting an operator that the reject drawer is full and requesting replacing the drawer.

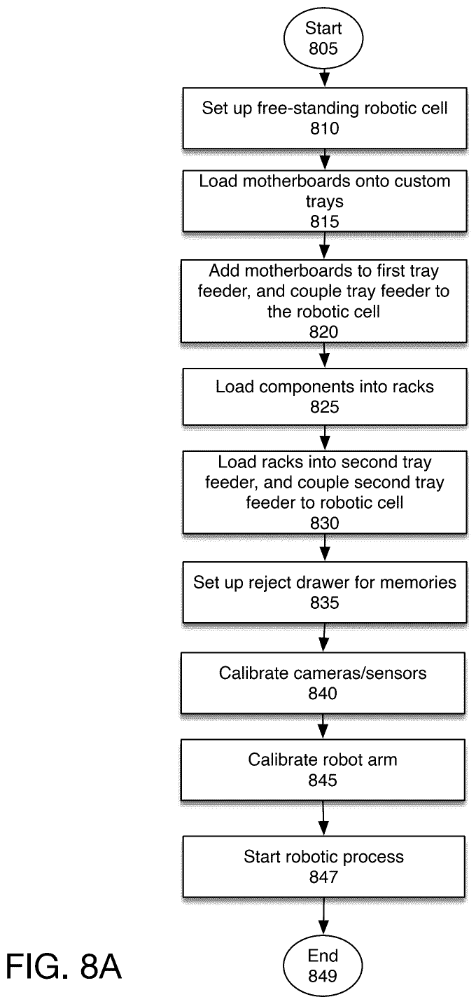

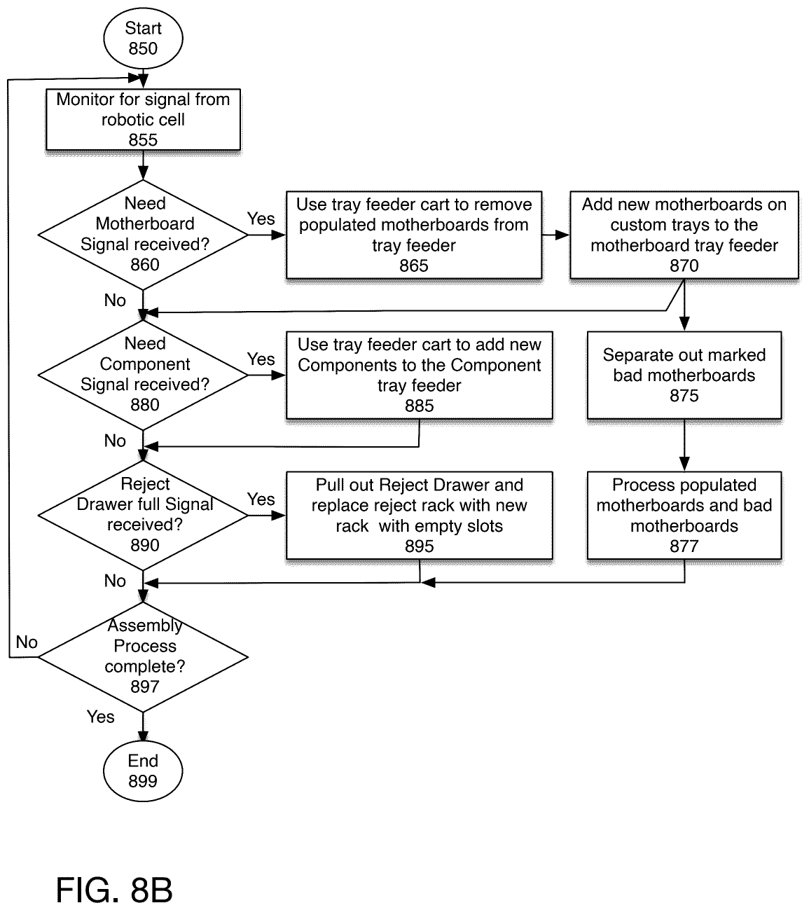

FIG. 8A is a flowchart of one embodiment of setting up for assembly. The process starts at block 805. At block 810, the freestanding robotic cell is set up. In one embodiment, the set-up of the robotic cell includes assembling the cell including one or more robot arms, end-of-arm tools appropriate for the components-to-be-inserted, one or more sensors, and one or more cameras. In one embodiment, the set-up further includes downloading the appropriate software which controls the robot arm and the robotic cell to the robotic cell.

At block 815, the motherboards are loaded onto the custom trays. The custom trays in one embodiment are standard trays from a tray feeder with the custom support base for the motherboard. In one embodiment, the motherboards are loaded manually. As noted above, each tray may have one or more motherboards, each separately supported.

At block 820, the motherboards on the trays are loaded into the first tray feeder, and the first tray feeder is coupled to the robotic cell. In one embodiment, the tray feeder is coupled to the robotic cell such that when the assembly process is active, an active tray with one or more motherboards for assembly is moved into the working area of the robotic cell, and a filled motherboard is removed from the working area of the robotic cell by the tray feeder. This obviates the need for a separate conveyor and reduces the footprint of the system.

At block 825, the components are loaded into the component racks on another set of trays. In one embodiment, the components are DIMMs. The racks support the components in a way that enables the robotic end-of-arm gripper to remove a component from the rack, for insertion into the motherboard.

At block 830, the filled racks are loaded into the second tray feeder, and the second tray feeder is coupled to the robotic cell. The second tray feeder is configured so that when the assembly process is active, an active tray with one or more racks of components is moved into the working area of the robotic cell, and an empty rack is removed from the working area by the second tray feeder.

At block 835, a reject drawer is set up. The reject drawer includes a reject component rack to take components which are rejected and not inserted into the motherboard. This completes the system set-up. This stand-alone robotic cell is capable of continuously assembling motherboards with components, as long as there is an operator to add new motherboards and components to the tray feeders, and remove trays with completed or rejected motherboards, empty component racks, and rejected components in the reject drawer.

At block 840, the cameras and sensors in the robotic cell are calibrated. The calibration ensures that the system can accurately locate the components in the component rack as well as the locations in the motherboard into which the components are assembled. This may take place in parallel to, or prior to the loading of the tray feeders.

At block 845, the robot arm is calibrated. In one embodiment, the calibrated cameras and sensors are used to calibrate the position of the robot arm. In one embodiment, this includes calibrating the position of the end of arm tool tip. This may take place in parallel to, or prior to the loading of the tray feeders.

At block 847, the set-up is complete, and the robotic assembly process may be initiated. The set-up process ends at block 849.

FIG. 8B is a flowchart of one embodiment of supporting the robotic cell during assembly. With the support of an operator, the present system can use the robotic cell to assemble more motherboards than a single tray feeder can hold without stoppage.

The process starts at block 850. In one embodiment, the process is initiated when the robotic assembly process is started. At block 855, an operator monitors for a signal from the robotic cell. In one embodiment, the monitoring is a continuous monitoring of the robotic cell. However, in one embodiment the monitoring may be interrupt-driven, with a signal being sent to a local operator. By utilizing this monitoring process, the robotic cell can assemble more motherboards than can be held by the first tray feeder, without stoppage.

At block 860, the process determines whether a “need motherboard” signal is received. This signal is prompted when the robotic cell has consumed all of the motherboards in the tray feeder, meaning that the robotic cell has either finished assembling or marked as defective each motherboard. In one embodiment, the signal is prompted when the tray with the last motherboard(s) is pulled in for assembly, so that the replacement process does not interrupt the assembly process.

If a “need motherboard” signal is received at block 865, the tray feeder cart is used to remove the motherboards that were consumed (assembled or marked defective). The new motherboards to be populated are then added to the tray feeder, at block 870. The process then returns to block 880.

Separately, the operator is prompted to remove the marked bad motherboards from the motherboards in the removed tray feeder. In one embodiment, motherboards that are defective or have an issue such as a stray cable or another issue which would make insertion of components problematic, are marked as “bad.” In one embodiment, the marking is in a genealogy cloud, which is used to track the status of each motherboard. In one embodiment, the marking may also include a physical marking. The physical marking may be on the motherboard, the custom support, and/or the tray. In one embodiment, the physical marking may be made by the robot arm.

In one embodiment, once the marked “bad” motherboards are separated at block 875, and the populated motherboards are further processed at block 877. In one embodiment, the “good” populated motherboards are moved to the next step in the assembly process. In one embodiment, the marked “bad” motherboards may be manually inspected to determine the cause of the marking. In one embodiment, if the cause can be easily rectified—such as a stray cable or a jammed DIMM latch—the operator may correct the issue, remove the marking, and reinsert the motherboard into the process flow, as a motherboard to be populated. The process then continues to block 897.

If the signal received was not a “need motherboard” signal, as determined at block 860, the process continues to block 880.

At block 880, the process determines whether the signal was a “component needed” signal. If so, at block 885, the tray feeder is used to add new components into the component tray feeder. In one embodiment, the empty component racks are removed, and new racks with components are added. As above, in one embodiment, the signal is sounded when the last tray with components is pulled, enabling the robotic cell to continue assembling, while the tray feeder is repopulated. The process then continues to block 890. If the signal was not a component needed signal, the process continues directly to block 890.

At block 890, the process determines whether the signal is that the reject drawer is full. If so, at block 895, the reject drawer is pulled out, the full reject rack is pulled out and replaced with an empty rack, to take the new rejected components. The drawer is then closed. Again, this should not interrupt the assembly process unless a new rejected component is identified during the seconds it takes to open and close the reject drawer. The process then continues to block 897. If the signal was not a reject drawer signal, the process continues directly to block 897.

At block 897, the process determines whether the assembly process is complete. If so, the process ends at block 899. Otherwise, the process returns to block 855 to continue monitoring the cell. In one embodiment, this process may include other alerts which would be handled by the operator or automatically by the system. For example, there may be alerts if recalibration is needed (due to movement, or because the robotic cell has determined that it is no longer accurate), a light bulb needs replacing, etc. Any such issues can be handled by a trained operator, with minimal interruption to the assembly process. In this way, with the support of a single operator, a single robotic cell can work to continuously assemble motherboards with components.

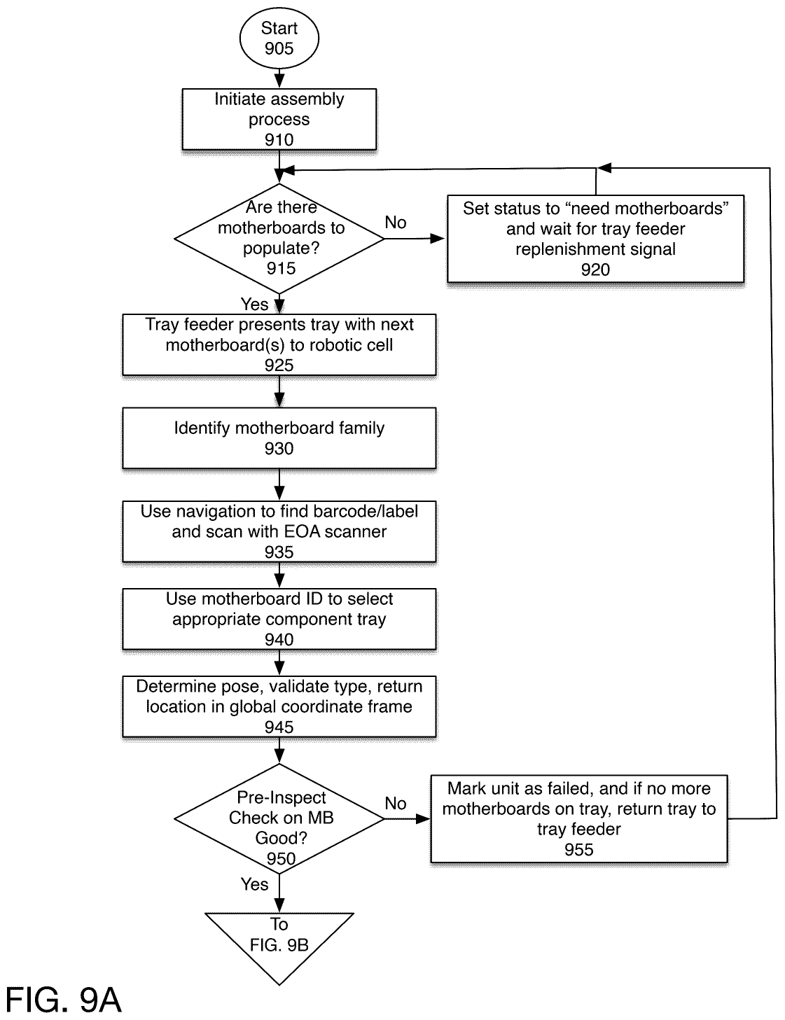

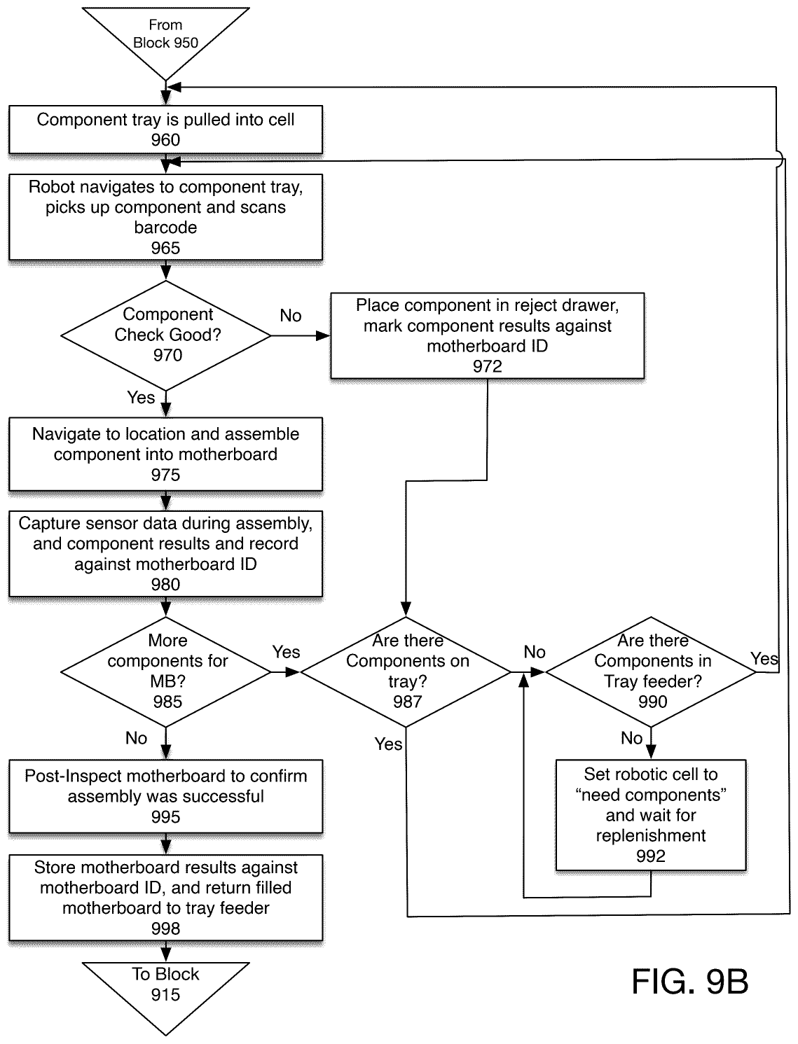

FIG. 9A-9B is a flowchart of one embodiment of assembling using the system. The process starts at block 905.

At block 910, the assembly process is initiated. As discussed above, this occurs after the robotic cell and two tray feeders are assembled and filled, and the cameras, sensors, and robot arm are calibrated.

At block 915, the process determines whether there are motherboards to populate. If not, an alert is sent at block 920, asking for more motherboards to be loaded into the tray feeder. After the alert is sent, the system monitors for the refill, and returns to block 915.

If there are motherboards to populate, the process continues to block 925. At block 925, the tray feeder presents a tray including the next one or more motherboards to the robotic cell. In one embodiment, the tray feeder pulls out the tray directly into the robotic cell.

At block 930, the motherboard family is identified. In one embodiment, the identification may be based on a visual identification of the appearance of the motherboard. In one embodiment, the identification may be based on the configuration of the custom support base for the motherboard. In one embodiment, the identification may be based on a barcode such as a QR code or UPC code on the motherboard and/or the tray. The motherboard family specifies the configuration of the components for insertion and specifies the location of the motherboard ID on the motherboard. The motherboard ID is unique to the individual motherboard and is used for tracking that particular motherboard through the assembly process.

At block 935, navigation is used to find the barcode/label on the motherboard, and it is scanned with an end-of-arm scanner. In one embodiment, the navigation utilizes the motherboard family determined above. In another embodiment, this step may be skipped, and the motherboard identification may be retrieved from a database. In that case, the motherboard identification is retrieved based on the tray count, and a previously scanned motherboard identification.

At block 940, the motherboard ID is used to select the appropriate component type for insertion. The component type may be for example, the specific configuration of DIMM components for this motherboard. The configuration may include the physical configuration as well as the capabilities of the component. For example, the motherboard ID may indicate that for this motherboard four 144 pin SDRAM (synchronous dynamic random access memory) SODIMMs (small outline dual in-line memory modules) should be used with 16 GB per module. In one embodiment, the motherboard family and individual motherboard ID is used to identify the component type and the number of components for insertion into the particular motherboard. This enables the system to assemble customized motherboards, which have different numbers of memory modules, for example, in the same assembly flow.

At block 945, the pose of the motherboard and type of the motherboard is validated using visual examination, and the locations for the component insertions are determined in a global coordinate frame. In one embodiment, the pose is estimated using stereo vision and/or 3D sensors and the motherboard type is validated using visual examination. In various embodiments, the top cameras may be used for this.

At block 950, a pre-inspection is performed on the motherboard to ensure that it is ready for the insertion of components. If the motherboard fails the inspection, the pre-inspection it is marked as failed, and the motherboard is marked as non-usable. The motherboard may fail the inspection for example if there are wires or other elements on the motherboard that would keep components from being insertable, if one or more of the component sockets/locations are obstructed or broken, etc. In one embodiment, the marking associates a “failed pre-inspection” status with the motherboard ID. If there are no more motherboards to populate on the tray, the tray is returned to the tray feeder, at block 955, and the next tray is pulled out. Otherwise, in one embodiment, the process returns to block 930, to scan the next motherboard on the tray.

If the motherboard passes the pre-inspection, at block 960 a component tray is pulled into the cell, unless there is already a component tray with the appropriate components in the cell. This process is independent of the motherboard being pulled into the system and the motherboard pre-inspection, in one embodiment, and may occur prior to or in parallel with that portion of the process.

At block 965, the robot arm navigates to the component tray, picks up a component from the component tray. In one embodiment, the end-of-arm scanner or camera scans a barcode on the component. In another embodiment, the barcode scan may take place manually or outside the robotic cell.

At block 970, the process performs a pre-inspection of the component to confirm that the component is good. In one embodiment, the component pre-inspection verifies that the component is the correct component for the motherboard, based on the barcode. In one embodiment, the component pre-inspection utilizes inspection cameras to confirm that the component is the correct component type. In one embodiment, the pre-inspection further verifies that the component does not exhibit any evidence of problems. For example, the visual inspection may confirm that all chips expected on the component are present and do not exhibit any evidence of failure, that the contacts are present, and that the component is not warped or otherwise damaged. For example, for a DIMM component, visual inspection may identify memory chips that are missing or damaged, or a contact that is damaged, or a memory chip that is the wrong size, or isn't securely attached.

If the component fails the component pre-inspection, the process continues to block 972. At block 972, the component is placed in the reject drawer, and the component result is marked against the motherboard ID. The process then continues to block 987.

If, at block 970, the component was found to be good, the process continues to block 975. At block 975, the robot arm navigates to the motherboard with the component and assembles the component into the motherboard. In one embodiment, for a DIMM component, the system first opens the latch and then inserts the DIMM component into the appropriate DIMM socket in the motherboard. The system closes the latches to secure the DIMM in the socket, to complete the insertion.

If the insertion fails, because the component cannot be successfully inserted into the socket, or the socket cannot be successfully latched, the system may retry the insertion. In one embodiment, if the insertion fails, the DIMM is rejected, and put in the reject drawer, and another DIMM is tried. In some embodiments, an attempt to insert a DIMM into a particular socket may be tried a number of times, in one embodiment three times. If it fails each time, the socket is skipped, and the insertion moves to the next socket. The empty socket is identified during post-inspection, and can be the basis for rejecting the motherboard. In some embodiments, before rejecting the DIMM, the system may try inserting the same DIMM into a different socket, to determine whether the issue is the component or the motherboard. If the issue is the component, the component is placed in the reject drawer, and the component result is marked against the motherboard ID. If the issue is with the motherboard, and multiple components fail insertion into a particular socket, the motherboard may be marked as failed. The motherboard ID is updated with the failure. In some embodiments, the motherboard may be physically marked.

If the component assembly succeeded, at block 980, the sensor data captured during the assembly and component results are recorded against the motherboard ID. In one embodiment, the sensor data captured during the assembly may include force data for the insertion of a component and/or image data of the component inserted into the motherboard. This information may be used not only for tracking the motherboard through the assembly process and potentially beyond, it may also be used for machine learning training to identify successfully inserted components.

At block 985, the process determines whether more components should be inserted into the motherboard. If so, the process at block 987 determines whether there are any more components for insertion on the tray that's in the robotic cell. If so, the process returns to block 965, to pick up the next component from the component tray. If there are no components remaining on the tray for insertion, at block 990 the process determines whether there are additional populated trays in the tray feeder. If so, the process continues to block 960, and the empty tray is returned to the tray feeder and a new tray with components is pulled into the robotic cell. If there are no trays in the tray feeder, the robotic cell sends a “need components” alert and waits for replenishment at block 992, and the process returns to block 990 to monitor for when the component tray feeder has been repopulated.

If there are no more components for insertion into this motherboard, as determined at block 985, the process continues to block 995.

At block 995, a post-inspection is performed on the motherboard to confirm that the assembly was successful. In one embodiment, the post-inspection verifies that each component has been successfully inserted into the motherboard, that there are no empty locations for components that should be filled, and that there are no indicators of malfunction or defect. If the motherboard fails the post-inspection, in one embodiment the motherboard is marked as failed in the database. In one embodiment, the motherboard, tray, or custom support base are also physically marked by the system. The post-inspection may include acquiring images of the motherboard and components, and may be stored as well.

At block 998, the motherboard results are stored against the motherboard ID, and the filled motherboard is marked as completed. The images acquired in the pre-inspection and post-inspection may be stored as well. This information may be used for training.

If there are no other motherboards on this tray, the tray with the filled motherboard(s) is returned to the tray feeder, and the process returns to block 915 to pull the next tray. If there is another motherboard on the tray, the process returns to block 935 to assemble the next motherboard on the tray.

In this way, the process can assemble motherboards with one or more components. In one embodiment, each of the components is the same type, and uses the same end-of-arm component. In another embodiment, there may be two or more types of components assembled into a motherboard, and the end of arm tool may be changed to match each component type. In some embodiments, the components may be assembled with an end-of-arm tool that is designed to handle all of the component types assembled into the motherboard, avoiding the need for changing the end of arm tool. In another embodiment, the robotic cell may include two robot arms with different end-of-arm tools, to assemble two different types of components into the motherboard.

Although the above flowchart indicates that if inspection or insertion is failed, the motherboard and/or component are marked as failed, in one embodiment, the system makes multiple attempts before identifying a motherboard or component as failed. In one embodiment, the system includes a recovery routine. A recovery routine resets the robot arm and components, to restart an assembly step. The recovery routine may include moving the robot arm to a neutral position and re-approaching the motherboard for insertion. The recovery routine may include returning the component to the component tray, regripping it, and attempting insertion into another socket on the motherboard, to address each of the potential points of failure. This is useful if the failure occurs at the assembly stage, and it's due to an error in navigation or grip. In one embodiment, the number of tries before a component is declared defective, and the number of tries before a motherboard is declared failed may be set by the operator.

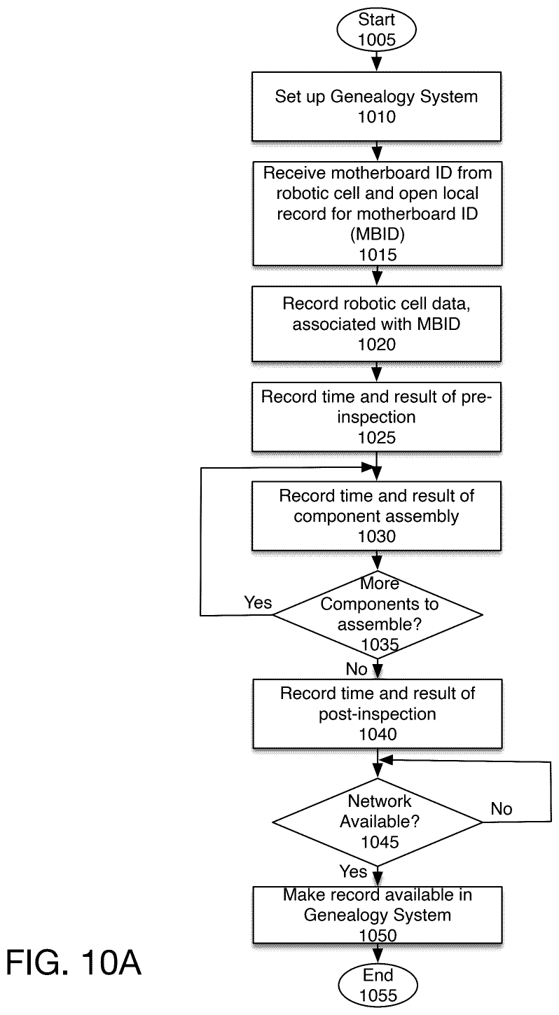

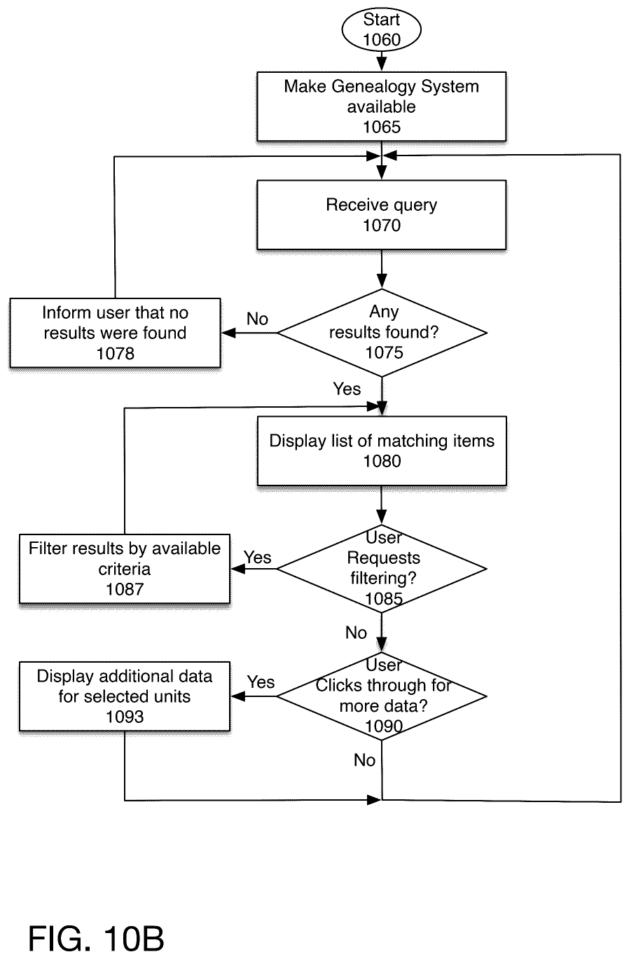

FIG. 10A is a flowchart of one embodiment of populating a Genealogy system for tracking each motherboard. The process starts at block 1005. At block 1010, a genealogy database is set up. The genealogy system is an accessible database or other storage structure for each of the robotic cells, motherboards, and components. The genealogy system allows tracking of motherboards, components, and processes. This permits full traceability and secure tracking of the intricate histories of every unit and component, ensuring both airtight security and efficient production, regardless of location. Setting up the genealogy system includes, in one embodiment, establishing the database or other storage format, and setting up search capability. In one embodiment, the genealogy system may be a cloud-based system set up on cloud infrastructure. In one embodiment, the genealogy system may include an on-premises system which can be used while offline. The genealogy system may include image data in addition to the text data, or may include links to image data, such as image data from the pre or post-inspection, stored in a separate system.

At block 1015, a motherboard ID (MBID) is received from a robotic cell, and a local record is opened for the MBID. In one embodiment, the robotic cell may not be connected to a network, in which case the initial data collection occurs on the robotic cell. In one embodiment, the software operating the robotic cell includes an instance of the genealogy cloud, for population with data collected from the assembly process. In one embodiment, the robotic cell uploads data to the Genealogy Cloud when network connection is available. In one embodiment, the updates to the genealogy cloud may be continuous. In another embodiment, the update may be sent periodically, for example upon the completion of a motherboard assembly, or after a certain amount of time has elapsed, or a certain amount of data has been collected.

At block 1020, the robotic cell data is associated with the MBID. In one embodiment, the robotic cell data includes information about location, configuration, and software version of the robotic cell. In one embodiment, the vendor which is operating the cell may also be recorded. In one embodiment, the identity of the operator may also be recorded. This data may be used at a later time to track causes for malfunctions, production quality and production speed, and other assembly details.

At block 1025, the time and results of the pre-inspection of the motherboard are recorded. In one embodiment, the results may include one or more images taken by the cameras of the robotic cell during inspection. The result may also include a positive or negative outcome of the pre-inspection.

At block 1030, the time and result of a component assembly into the motherboard is recorded. In one embodiment, the results may include the sensor data recorded during the assembly, and may include one or more images, sequences of images, or videos of the assembly step. In one embodiment, the component identification is also recorded, if that data is available. In one embodiment, the result data recorded and associated with the motherboard ID and optionally the component ID may include identity data, load cell data, image data, 3D data, sensor data, data derived from sensor data, etc.

At block 1035, the process determines whether there are more components to assemble with this motherboard. If so, the process returns to block 1030, to record the data of the next component. If there are no more components, the process continues to block 1040.

At block 1040, the process records the time and result of the post-inspection. The results may include sensor data including photos, videos, or a series of images of the motherboard including the components. The results may also include data derived from the sensor data, such as point clouds and 3D data.

At block 1045, the process determines whether there is a network connection to upload the collected genealogy data to the cloud server. If not, the process waits until a network is available. Once the network is available, the record is uploaded to the cloud server, at block 1050. The process then ends at block 1055. In one embodiment, the software spawns a process for the flow from block 1015 through block 1050 for each motherboard. Thus, in one embodiment the system collects detailed data for each motherboard assembled and makes it available through a cloud interface. Although this process is focused on the motherboard assembly, one of skill in the art would understand that the genealogy cloud interface, and collection of data may be used through all stages of a product manufacturing and assembly process.

FIG. 10B is a flowchart of one embodiment of utilizing a Genealogy Cloud for tracking each motherboard. The process starts at block 1060. At block 1065, the genealogy cloud is made available to users.

At block 1070, a query is received. The query may be for a particular motherboard, a particular component, a particular robotic cell, etc. In one embodiment, the query may be based on one or more of: motherboard ID number, part family, serial number, part number, robotic cell identifier. The query may be to find a motherboard that was processed, to identify a motherboard that was later identified to have a problem, to track production, or for another reason.

At block 1075, the process determines whether results were found. If no results were found, at block 1078 the user is informed, and the process returns to wait for a new query. If results were found, the system displays a list of matching items. In one embodiment, for example, for a motherboard ID search, the system returns information about when the motherboard was assembled and the components which were added to the motherboard. In one embodiment, for each component, the system further provides the inspection results.

At block 1085, the process determines whether the user has requested filtering. In one embodiment, the results may be filtered based on start and end time, sorting criteria, or specific page to view. If filtering is requested, at block 1087, the system filters the results by the available criteria. The process then returns to block 1080 to display the list of matching items, in the preferred order.

At block 1090, the process determines whether the user has clicked through for more data. In one embodiment, the user can select any motherboard, component, etc., listed in the results page, and click for more information. At block 1093, the additional information is displayed. In one embodiment, the additional information may include the image and other sensor data captured at the time the component was assembled, images from the pre- and post-inspection, etc. The user may be able to back out of the more-detailed display into the original list. Or the user may end the search. If the user ends the search, the process returns to block 1070 to await a new query.

In this way, the genealogy web provides a web interface that allows original equipment manufacturers (OEMs) and contract manufacturers (CMs) to securely track the intricate histories of every unit and component, ensuring both comprehensive security and efficient production. The Genealogy Cloud offers uncompromising quality, providing a reliable means to maintain thorough traceability and validate component quality with confidence. It allows an authorized user to delve into production history, trace each component's journey, and consistently ensure high standards are met.

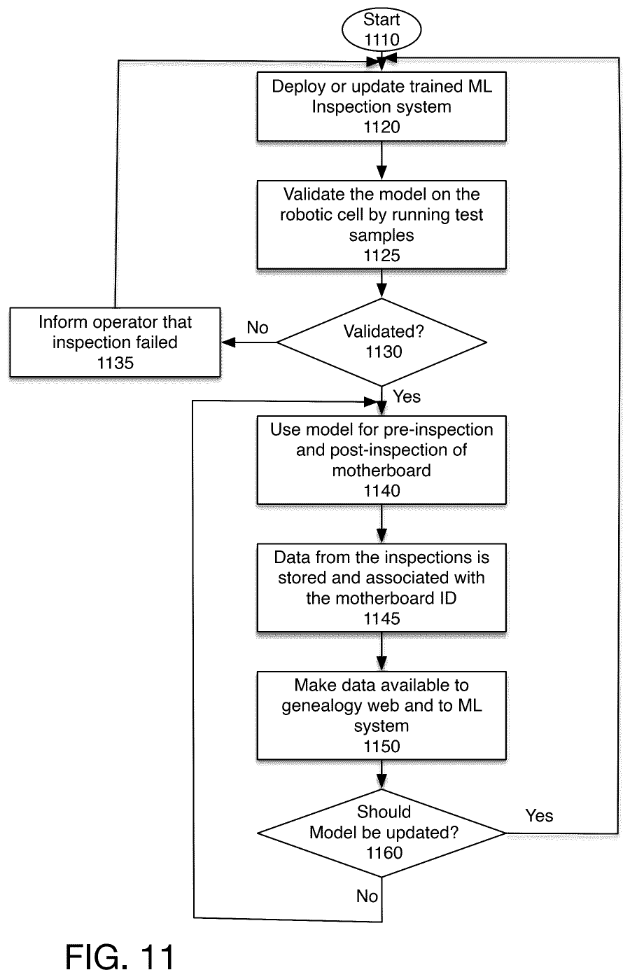

FIG. 11 is a flowchart of one embodiment of inspection of the motherboard. This process may be used for the pre-inspection, and the post-inspection of the motherboard, in some embodiments. The process starts at block 1110.

At block 1120, a trained machine learning (ML) inspection system is deployed to the robotic cell. In one embodiment, the robotic cell includes one or more processors to execute the inspection system. In some other embodiments, the inspection system may rely on remote processing capabilities.

The process of training the machine learning inspection system includes using captured training images. The physical part (motherboard) is scanned to generate a 3D navigation model. Specific regions of interest are created in the 3D navigation model for each specific inspection area on the board. The regions of interest (ROIs) correspond to areas where components were inserted, and areas which may interfere with the insertion of such components. The ROIs also include any latches or sockets that need to be closed or locked after insertion. A robotic cell with top cameras, end-of-cameras, and/or 3D sensors may be used to obtain this data. The data is then augmented, by moving the board, moving the parts with-in the board to capture the data from multiple angles. Good and bad sample dataset is captured separately. In one embodiment, for bad samples, known defect/anomaly is introduced. The labels are automatically generated based on the 3D ROIs and the labels assigned during the capture. In one embodiment, roughly, 200 to 1000 good and bad samples are captured for training and testing using the physical samples provided. The model is validated on a line with physical samples. The model is versioned, approved for production, and deployed to the robotic cell.

At block 1125, the ML inspection system model is validated on the robotic cell by running test samples, to confirm that the inspection system works. If the validation fails, at block 1130, the operator is alerted that the inspection model has failed, at block 1135. The operator may obtain an updated inspection model, in one embodiment. This may occur when the inspection system isn't updated for the particular motherboard model being used, for example. The process returns to block 1120 to receive the updated trained ML inspection system.

At block 1140, the inspection model is used for the pre-inspection of motherboards prior to the insertion of components, and for the post-inspection of motherboards after all components have been inserted.

At block 1145, data from the inspection is stored and associated with the motherboard ID. The data may include images, video, At block 1150, the record for the motherboard is made available to the genealogy system, as well as to the ML system.

At block 1160, the process determines whether the inspection model running on the robotic cell should be updated, based on the collected data from inspections, including frequency of issues, and accuracy of inspection results. If so, the process returns to block 1120, to deploy the updated trained ML system. This provides continuous ML training.

Otherwise, the process returns to block 1140, to continue using the model for inspection.

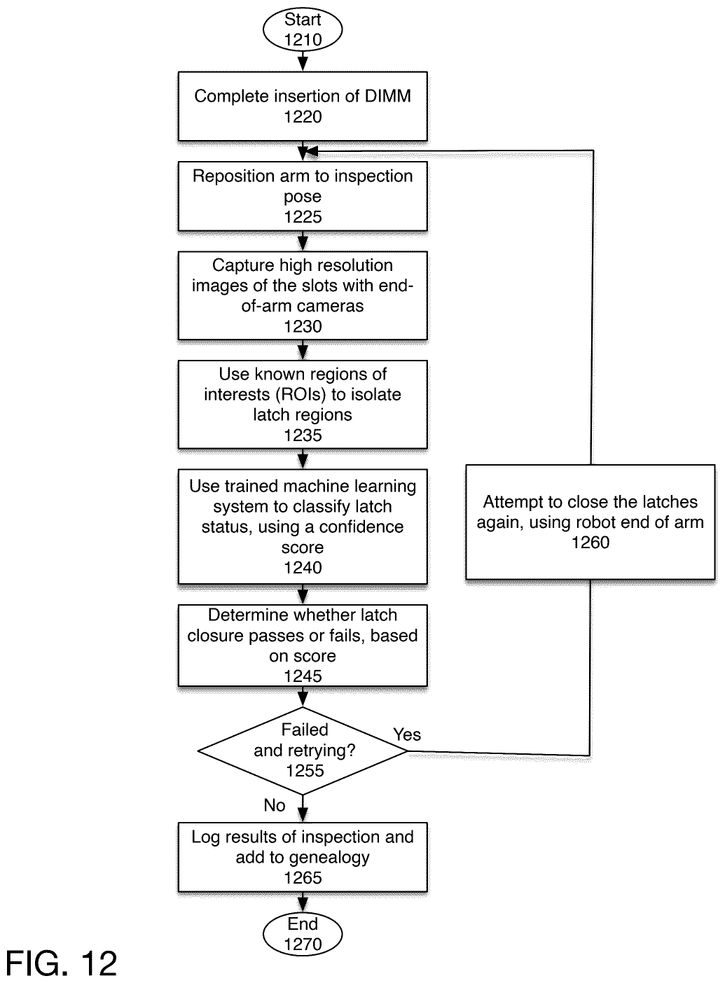

FIG. 12 is a flowchart of one embodiment of latch inspection using end of arm cameras. One of the post-inspections, for DIMM components is verifying that the DIMM latches are properly closed. This flowchart provides details for this inspection. This process takes place along with insertion, in one embodiment. The process starts at block 1210.

At block 1220, the robot arm completes the insertion of the DIMM into the socket. This comprises, in one embodiment: picking up a DIMM, performing a pre-inspection, and if the DIMM passes pre-inspection moving to the socket, and inserting the DIMM, and then automatically closing the DIMM socket latches.

After completing the inspection, the arm is repositioned to the inspection pose, at block 1225. The inspection pose is designed to enable the end-of-arm cameras on the robot arm to capture the socket slots, including the latches at both ends of the socket.

At block 1230, high resolution images are captured of the slots with the end of arm cameras. In one embodiment, there are a number of images captured, as the robot arm moves in a pattern, to ensure that the entirety of the area of interest is captured.

At block 1235, the known regions of interest (ROIs) for the latch regions are isolated. In one embodiment, the system knows that the latches are on both ends of the DIMM socket, and the regions of interest are defined at the two ends of the socket.

At block 1240, a trained machine learning system is used to classify the latch status, as one of: open, closed, or unclear. The goal is for the latch to be closed, at the time of inspection. The robot arm when it inserts the DIMM into the socket is designed to also close the socket. The trained machine learning system in one embodiment uses a Vision Transformer-based supervised learning model with a classification head. Vision Transformers (ViTs) are a known form of alternative to a convolutional neural network (CNN) for computer vision applications, incorporating a self-attention mechanism. A supervised learning model uses classified input-output pairs to train the machine learning system. The classification head provides the labeling of bad/good or in this case latch closed/latch open/indeterminate, in one embodiment. Alternative machine learning systems may be used.

The output of the trained machine learning system determines whether the latch closure passes or fails, and assigns a confidence score, at block 1245. If the confidence score is above a threshold, the latch closure is marked as passing. Below that it is marked as not passing. The system may further classify whether the latch is open, or in an indetermined third state.

At block 1255 the process determines whether the latch closure failed. If so, at block 1260, the process attempts to close the latch. In one embodiment, this is done by putting force on the DIMM to finish the insertion, and close the latch. In one embodiment, the end of arm tool is used to push down the DIMM, which should automatically lead to the latches closing.

The process then returns to block to reposition the arm for inspection again. In some embodiments, the system tries to close the latch three times, prior to marking the latch closure as failed. The number of times the system retries may be set by the operator. In some embodiments, the retrying depends on the identified failure.

For example, if the system determines the latch is not closed but also determines that the latch is not present, indicating that the latch may have broken off or is somehow damaged, it may not attempt to close the non-existent latch.

If the latch inspection is passed, at block 1265, the inspection results are logged and added to the genealogy of the motherboard. If prior iterations failed, the system logs that as well for traceability and analytics. The process then ends at block 1270.

Of course, though FIGS. 8A-12 are shown as flowcharts, in one embodiment the order of operations is not constrained to the order illustrated, unless the processes are dependent on each other. Furthermore, in one embodiment the system may be implemented as an interrupt-driven system, and thus the system does not check for an occurrence, but rather an occurrence or detection of status sends a notification to trigger actions.

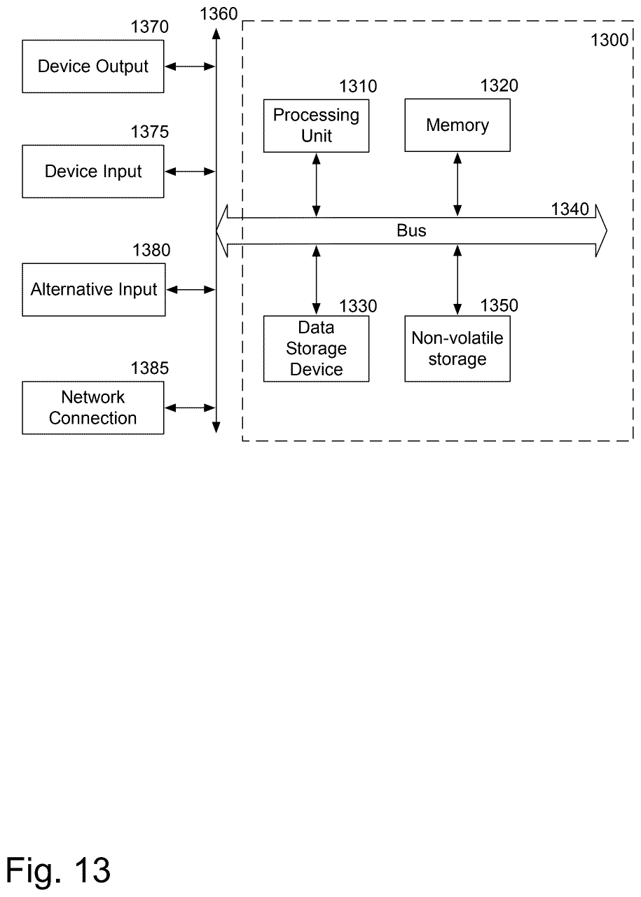

FIG. 13 is a block diagram of a particular machine that may be used with the present invention. It will be apparent to those of ordinary skill in the art, however that other alternative systems of various system architectures may also be used.

The data processing system illustrated in FIG. 13 includes a bus or other internal communication means 1340 for communicating information, and a processing unit 1310 coupled to the bus 1340 for processing information. The processing unit 1310 may be a central processing unit (CPU), a digital signal processor (DSP), or another type of processing unit 1310.

The system further includes, in one embodiment, a random access memory (RAM) or other volatile storage device 1320 (referred to as memory), coupled to bus 1340 for storing information and instructions to be executed by processor 1310. Main memory 1320 may also be used for storing temporary variables or other intermediate information during execution of instructions by processing unit 1310.

The system also comprises in one embodiment a read only memory (ROM) 1350 and/or static storage device 1350 coupled to bus 1340 for storing static information and instructions for processor 1310. In one embodiment the system also includes a data storage device 1330 such as a magnetic disk or optical disk and its corresponding disk drive, or Flash memory or other storage which is capable of storing data when no power is supplied to the system. Data storage device 1330 in one embodiment is coupled to bus 1340 for storing information and instructions.

The system may further be coupled to an output device 1370, such as a cathode ray tube (CRT) or a liquid crystal display (LCD) coupled to bus 1340 through bus 1360 for outputting information. The output device 1370 may be a visual output device, an audio output device, and/or tactile output device (e.g. vibrations, etc.)

An input device 1375 may be coupled to the bus 1360. The input device 1375 may be an alphanumeric input device, such as a keyboard including alphanumeric and other keys, for enabling a user to communicate information and command selections to processing unit 1310. An additional user input device 1380 may further be included. One such user input device 1380 is cursor control device 1380, such as a mouse, a trackball, stylus, cursor direction keys, or touch screen, may be coupled to bus 1340 through bus 1360 for communicating direction information and command selections to processing unit 1310, and for controlling movement on display device 1370.

Another device, which may optionally be coupled to computer system 1300, is a network device 1385 for accessing other nodes of a distributed system via a network. The communication device 1385 may include any of a number of commercially available networking peripheral devices such as those used for coupling to an Ethernet, token ring, Internet, or wide area network, personal area network, wireless network or other method of accessing other devices. The communication device 1385 may further be a null-modem connection, or any other mechanism that provides connectivity between the computer system 1300 and the outside world.

Note that any or all of the components of this system illustrated in FIG. 13 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1320, mass storage device 1330, or other storage medium locally or remotely accessible to processor 1310.

It will be apparent to those of ordinary skill in the art that the system, method, and process described herein can be implemented as software stored in main memory 1320 or read only memory 1350 and executed by processor 1310. This control logic or software may also be resident on an article of manufacture comprising a computer readable medium having computer readable program code embodied therein and being readable by the mass storage device 1330 and for causing the processor 1310 to operate in accordance with the methods and teachings herein.

The present invention may also be embodied in a special purpose appliance including a subset of the computer hardware components described above, for example for a robotic cell. For example, the appliance may include a processing unit 1310, a data storage device 1330, a bus 1340, and memory 1320, and no input/output mechanisms, or only rudimentary communications mechanisms, such as a small touchscreen or an alert button or speaker that permits communication with an operator. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 1385.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1310. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method of inserting components into a motherboard comprising:
setting up a robotic cell including an end-of-arm tool;
attaching a first tray feeder including a plurality of trays, each of the trays including one or more motherboards;
attaching a second tray feeder including a plurality of trays with the components;
loading a motherboard from the first tray feeder;
identifying the motherboard;
identifying a component type based on the identifying of the motherboard;
retrieving a tray with one or more components of the identified component type from the second tray feeder; and
inserting the components into the motherboard.

2. The method of claim 1, further comprising:
inspecting the motherboard after the components have been inserted; and
updating a database with a status for the motherboard, upon successful inspection.

3. The method of claim 2, further comprising:
collecting sensor data during the inserting and storing the sensor data in the database associated with the motherboard.

4. The method of claim 2, further comprising:
returning the motherboard with the components to the first tray feeder; and
pulling a new motherboard from the first tray feeder, the new motherboard placed in the robotic cell for populating with the components.

5. The method of claim 1, further comprising:
picking up a component for insertion;
scanning the component for insertion to confirm a match to the component type.

6. The method of claim 1, wherein the robotic cell is a stand-alone cell.

7. The method of claim 1, further comprising:
replenishing the tray feeders during an operation of the robotic cell, such that the robotic cell can populate more motherboards than the first tray feeder can hold, without stoppage.

8. The method of claim 1, further comprising:
loading the first tray feeder with a plurality of motherboards, each of the motherboards supported by a custom support base, the custom support base providing a structure to stabilize the motherboard during the inserting.

9. The method of claim 1, further comprising:
pre-inspecting of the motherboard before inserting the components;
marking a failed motherboard as non-usable;
updating a database with a motherboard identifier for the failed motherboard; and
returning the motherboard to the first tray feeder.

10. The method of claim 9, further comprising:
placing a physical marking for the failed motherboard, the physical marking placed on one or more of: the failed motherboard, a custom support base of the failed motherboard, or a tray on which the custom support base is positioned.

11. A method of inserting components into a motherboard comprising:
setting up a robotic cell including an end-of-arm tool and one or more tray feeders, the one or more tray feeders including a plurality of trays with motherboards and a plurality of trays with components;
moving a first tray including a motherboard into the robotic cell;
identifying the motherboard;
moving a second tray including one or more components for insertion into the motherboard into the robotic cell; and
inserting the components from the second tray into the motherboard.

12. A motherboard assembly system using a robotic cell comprising:
a robot arm in the robotic cell including an end-of-arm tool;
a first tray feeder including a plurality of trays, each of the trays including one or more motherboards;
a second tray feeder including a second plurality of trays with components;
a sensor to obtain data from the motherboard to identify a motherboard;
a processor to identify a component type based on the identifying of the motherboard;
the second tray feeder providing a second tray with one or more components of the identified component type; and
the robot arm to pick up a component from the second tray and assemble it into the motherboard.

13. The system of claim 12, further comprising:
the sensor further configured to inspect the motherboard after the components have been inserted; and
a database to store a status for the motherboard upon successful inspection.

14. The system of claim 13, further comprising:
the plurality of sensors further to collect sensor data during the inserting;
wherein the database is further to store the sensor data in the database associated with the motherboard.

15. The system of claim 12, further comprising:
the first tray feeder configured to return the motherboard populated with the components to the first tray feeder and pull a new motherboard into the robotic cell for populating with the components.

16. The system of claim 12, further comprising:
the robot arm configured to pick up a component for insertion; and
a scanner further configured to scan the component for insertion to confirm a match to the component type.

17. The system of claim 12 further comprising:
a custom support base on the trays in the first tray feeder for the motherboards.

18. The system of claim 17, wherein the custom support base includes a plurality of spring plungers to position the motherboard for insertion of the components.

19. The system of claim 15, further comprising:
the sensors further to perform a pre-inspection of the motherboard before inserting the components and to perform a post-inspection of the motherboard after inserting the components;
the robotic cell further to mark a failed motherboard that fails the pre-inspection or the post-inspection, and to update a database with a motherboard identifier for the failed motherboard; and
the first tray feeder to receive the failed motherboard.

20. The system of claim 12, further comprising:
the sensors further to perform a pre-inspection of the component before inserting the component;
the robotic cell to identify a failed component; and
a reject drawer to receive the failed component.
